(19) United States
(12) Patent Application Publication
(10) Pub. No.: US 2007/0098858 A1
(43) Pub. Date: May 3, 2007

(54) Method of producing processed food

(75) Inventors: Chie Masuyama, Osaka (JP); Kazunori Sonobe, Osaka (JP); Yasushi Morishita, Osaka (JP); Takeshi Kawamukai, Osaka (JP); Shigeki Satomi, Osaka (JP); Hiroki Nakata, Osaka (JP); Shoichi Ito, Osaka (JP); Katsue Tsuneizumi, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOUSE FOODS CORPORATION, Higashiosaka-shi (JP)

(21) Appl. No.: 11/528,364

(22) Filed: Sep. 28, 2006

(30) Foreign Application Priority Data
Sep. 30, 2005 (JP) 2005-289313

(51) Int. Cl. A23L 1/00

(52) U.S. Cl. 426/302

(57) ABSTRACT

The present invention provides a solid food, a cooked food containing the solid food as an ingredient thereof, and a method for producing the same, and the present invention relates to a method for producing a solid food imparted with a function of maintaining texture and improving storageability, comprising: (a) contacting an alkaline substance and a coating substance with the surface of a solid food; (b) coating the surface of the food with the coating substance by placing the food in an atmosphere at a temperature equal to or higher than the temperature at which the protein in the food is denatured by heat and the coating substance forms a coating; (c) heating the food under conditions equivalent to or more than a temperature of 80° C. for 15 minutes; and (d) carrying out at least the treatment of (a) to (c) in that order, as well as a solid food produced according to this process, and a cooked food containing the solid food as an ingredient thereof, and as a result, the present invention is able to provide a solid food such as meat or seafood which does not demonstrate a decrease in quality even when stored for a long period of time and has superior storageability, a cooked food containing the solid food as an ingredient thereof, and a method for producing the same.

### BACKGROUND OF THE INVENTION

1. Field of the Invention

The present invention relates to a method of producing processed solid foods such as meat and seafood having a long shelf life imparted with function which maintains food texture and improves storageability, and more particularly, to a method of producing processed solid foods (including prepared foods containing the processed solid foods as ingredients thereof) which stably maintains the soft texture of foods such as meat and seafood and is free of decreases in quality even when stored for intermediate or long periods of time, and to a product thereof.

2. Description of the Related Art

Various methods have been reported in the past for improving the texture and quality of ingredients such as meat and seafood by using alkaline substances or modifiers such as starch. For example, the related art proposes a process for improving the texture of prepared meat by allowing a carbonate solution and/or hydrogen carbonate solution to penetrate into meat, followed by boiling, steaming or sauteing, and finally sterilizing by heating under pressure as a process for producing processed meat (Japanese Patent Application Laid-open No. 2000-78957). However, in this type of process, effects for improving texture, yield and so on are inadequate. Although texture and yield can be improved by increasing the concentration of alkaline substance, there are problems that a bitter taste, pungency or an alkaline odor is generated irreversibly.

In addition, in other example of the related art, a modifier for protein-containing food containing an alkaline substance, starch and water, and a process for improving protein-containing foods which uses that food modifier, are proposed as a modifier for protein-containing food and process for improving protein-containing foods (Japanese Patent Application Laid-open No. 2003-9821). Although this document discloses the composition of a modifier containing an alkaline substance, starch and water, there is no disclosure of the relationship between the conditions under which this modifier acts and the subsequent heat (sterilization) treatment for imparting a function for improving storageability to foods, and, similar to Japanese Patent Application Laid-open No. 2000-78957, it is necessary to add a large amount of an alkaline substance to obtain a desirable texture, and therefore, there was the problem that a bitter taste, pungency or an alkaline odor due to the addition thereof is generated.

### SUMMARY OF THE INVENTION

With the foregoing in view, depending on the treatment conditions thereof, any effects are not exhibited even if treatment is carried out in accordance with this type of process, and therefore, the inventors of the present invention conducted extensive studies and found that it is important to retain an alkaline substance on the surface of a food, and form a coating on the surface by depositing a coating substance, thereby leading to completion of the present invention. An object of the present invention is to provide a method of producing processed solid foods such as meat or seafood, as well as prepared foods having the processed meat and so on as ingredients thereof, which have extremely superior texture and yield, have satisfactory taste with little bitter taste, pungency or alkaline odor caused by the use of an alkaline substance, do not suffer decreases in quality even when stored for long periods of time, and exhibit superior storageability.

The present invention is composed of the following technical means to solve the above-mentioned problems.

(1) A method for producing a solid food imparted with an action of maintaining texture and improving storageability, comprising:

(a) contacting an alkaline substance and a coating substance with the surface of a raw solid food in which proteins have not been denatured by heat;
(b) coating the surface of the food with the coating substance by placing the food in a condition at a temperature equal to or higher than the temperature at which the protein in the food is denatured by heat and the coating substance thickens to form a coating;
(c)heating the food under conditions equivalent to or more than a temperature of 80° C. for 15 minutes; and (d)carrying out at least the treatment of (a) to (c) in that order.
   (2) The method described in (1) above, wherein the alkaline substance is a carbonate, hydrogen carbonate or organic acid salt.
   (3) The method described in (1) above, wherein starch is used for the coating substance, and said coating treatment is carried out by coating in a condition at a temperature equal to or higher than the gelatinization temperature of the starch.
   (4) The method described in (1) above, wherein the contact treatment of (a) is carried out such that the alkaline substance and coating substance thinly and uniformly adhere to the surface of the solid food.
   (5) The method described in (1) above, wherein a powdered alkaline substance and coating substance are contacted with the surface of the solid food.
   (6) The method described in (1) above, wherein a mixed solution, in which the concentration of the alkaline substance is 0.1 to 40% by weight, the concentration of the coating substance is 30 to 70% by weight, and ratio of the water is 30 to 70% by weight, is contacted with the surface of the solid food.
   (7) The method described in (1) above, wherein the alkaline substance and the coating substance are contacted with the surface of the solid food, and the solid food coated with the coating substance on the surface thereof is filled into a sealed container together with a flavoring liquid, or the surface of the solid food is coated with the coating substance when filling the solid food, for which the surface has been contacted with the alkaline substance and coating substance, into a sealed container together with a flavoring liquid, or when heating the solid food after filling.
   (8) The method described in (1) above, wherein, in the case where the processed solid food has been contacted with a dyeing agent which reacts with the coating substance at a cut cross-section thereof, the dye is able to be confirmed at least on the surface portion of the cross-section.
   (9) A processed meat for persons with depressed swallowing or chewing function, the processed meat being imparted with a function of maintaining texture and improving storageability, wherein the food is a meat which is subjected to heat treatment, retains an alkaline substance on the surface thereof, is coated with a coating substance, has a thickened coating formed on the surface thereof, is not subjected to shaping treatment, has a volume of 500 to 250000 mm³ or more, has a maximum stress of 5×10⁴ N/m² or less, and has a pH of 6 to 7.

The following provides a more detailed explanation of the present invention.

The present invention is a method of producing a processed solid food imparted with a function which maintains food texture and improves storageability: comprising: (a) contacting an alkaline substance and a coating substance with the surface of a raw solid food in which proteins have not been denatured by heat; (b) coating the surface of the food with the coating substance by placing the food in an atmosphere at a temperature equal to or higher than the temperature at which the protein in the food is denatured by heat and the coating substance thickens to form a coating; (c) heating the food under conditions equivalent to or more than a temperature of 80° C. for 15 minutes; and (d) at least carrying out the treatment of (a) to (c) in that order.

Examples of a target raw material of the present invention include solid foods such as red meat, seafood and other meat, vegetables, beans, fruits, and cheese and other dairy products. In particular, the present invention is applicable to meat, including red meat such as beef, pork, poultry and veal, and seafood such as fish, shrimp, squid and shellfish. As a result of these foods being processed in a state in which a coating substance to be described later is in contact with the surface or the surface and interior of the foods, the surface and the surface and or interior is subjected to thermal denaturation, the coating substance is adhered at least to the surface portion, and the foods have the properties of being coated. Although raw foods, namely foods in which proteins have not been denatured by heat, are typically used due to this action, solid foods are not limited thereto, but rather foods to which heat has been applied to a portion thereof are also used. In addition to raw solid foods, frozen and semi-thawed foods are also used.

There are no particular limitations on the size of the solid food, and for example, after carrying out the treatment of the present invention on blocks of raw solid food having a volume of about 75 to 320000 mm³ (for example, measuring 5 to 80 mm×5 to 80 mm×3 to 50 mm) or on slices of raw solid food having a volume of 1000 to 1200000 mm³ (for example, measuring 10 to 200 mm×10 to 200 mm×10 to 30 mm), the yield to be described later of the final product is preferably 70% or more, preferably 73% or more, and more preferably 75% or more. According to the present invention, in the case of solid food of this size, in addition to being able to impart the function of maintaining food texture and improved storageability, the remarkable effect is obtained of being able to achieve retention of food texture and storageability while using ordinarily cut natural materials and taking advantage of the sensation associated with the use of ingredients of sufficient volume. In addition, in the present invention, the “imparting of function which maintains food texture and improves storageability” refers to having performance enabling the inherent food texture to be maintained throughout distribution and storage in the case of a solid food being supplied in a form having storageability which allows commercial distribution. This particularly refers to fluctuations in moisture retention, yield and pH being suitably regulated so that a food has inherent softness without becoming hard.

In the present invention, “heat treatment” refers to heat treatment of a food in an open or sealed state, examples of which include heat treatment by a heating device such as a heating cooker, heat sterilization treatment in the medium temperature range for chilled foods, and pressurized heat sterilization treatment for pre-cooked foods. A “sealed state” refers to heat treating a food after filling into a sealed container, or heat treating a food with a sealed heat sterilization device and so forth without filling into a container (so-called sterile filling treatment), and heat treatment in a sealed state is preferable in terms of imparting the desired function of maintaining food texture and improving storageability. In the present invention, the above-mentioned heat treatment is an important constituent for imparting the function of maintaining food texture and improving storageability to a food together with treatment involving an alkaline substance and coating substance. In the present specification, a food which has undergone heat treatment may be referred to as a “heat-treated food”. In the present invention, heat treatment under conditions equal to or greater than conditions of 80° C. for 15 minutes refers to heat treating the above-mentioned food under conditions of a temperature of 80° C. or higher and for a duration equal to or longer than applying heat equivalent to 15 minutes at 80° C., and this applies similarly to other heating conditions as well.

Next, an explanation is provided of the alkaline substance and coating substance used in the present invention. Any alkaline substance can be suitably used for the alkaline substance provided it demonstrates alkalinity when dissolved in water. Examples of alkaline substances which can be used include bases such as alkaline metal and alkaline earth metal hydroxides, and salts thereof formed with weak acid, and specifically substances containing alkaline metal salts or alkaline earth metal salts. More specifically, substances like those indicated below can be used. Namely, this includes substances having the action of buffering pH to the alkaline side, such as salts formed from an acid having an acid dissociation constant pKa of 4 or higher, preferably 5 or higher and more preferably 6 or higher, and a base. In other words, these substances satisfactorily demonstrate buffering action such that a solid food is maintained at a more alkaline pH, such as a pH of 5.5 to 7.5, preferably pH 6 to 7, than a liquid component and so on in the case of combining the solid food with a liquid component having a lower pH.

Examples of the above-mentioned alkaline substance include hydroxides in the form of alkaline metal hydroxides (such as sodium hydroxide or potassium hydroxide), alkaline earth metal hydroxides (such as calcium hydroxide), and magnesium hydroxide. Other examples include carbonates in the form of alkaline metal carbonates, alkaline earth metal carbonates and magnesium carbonate. Examples also include bicarbonates in the form of alkaline metal bicarbonates (such as sodium bicarbonate), alkaline earth metal bicarbonates and magnesium bicarbonate. Other examples include organic acid salts in the form of alkaline metal organic acid salts (such as sodium acetate, trisodium citrate, disodium succinate, sodium tartrate, sodium hydrogen tartrate, disodium malate, sodium ascorbate or sodium gluconate), alkaline earth metal organic acid salts (such as calcium lactate), and magnesium organic acid salts. In addition, examples also include phosphates in the form of alkaline metal phosphates, alkaline earth metal phosphates and magnesium phosphate. Among these, carbonates and bicarbonates are preferable, while sodium bicarbonate and organic acid salts, and especially trisodium citrate, are particularly preferable. The function of maintaining food texture and improving storageability can be preferably imparted by maintaining a solid food at the above-mentioned pH by using this alkaline substance.

Next, in the present invention, the coating substance is defined as that which refers to a substance for which moisture retention improves due to swelling as a result of heating with water, specific examples of which include carrageenan, agar, alginic acid and salts thereof, locust bee gum, tara gum, tamarind seed polysaccharide, gum arabic, karaya gum, tragacanth gum, pullulan, curdlan, starch and processed starch. Any suitable starch can be used for the starch provided it contains starch in components thereof, examples of which include potato starch, wheat starch, cornstarch, tapioca starch, glutinous rice starch and processed starches thereof, and flour. In the present invention, although effects can be demonstrated by using one type of coating substance, it is also possible to combine the use of two or more types of coating substances. Cornstarch is particularly preferable. The starch has a gelatinization temperature of about 45 to 100° C., and preferably about 80 to 100° C. The use of these starches enables coating action to be demonstrated more favorably, increases the yield of the prepared solid food, and enables coating action to be demonstrated satisfactorily even in cases in which solid foods are heat-treated at high temperatures such as in the case of pre-cooked foods.

In the present invention, although contact treatment is carried out in which the alkaline substance and coating substance are contacted with the surface of a solid food, in this case, it is important that the coating substance which swells in the presence of water on the surface of the solid food to improve moisture retention be contacted with the solid food in an unswollen state. However, that in which a swollen coating substance is contained in a substance in the unswollen state is included in the scope of the present invention.

In the present invention, there are no particular limitations on the amount of alkaline substance added, it is preferable in terms of flavor and yield to compose the present invention such that the pH on the surface when acting on the solid food is 6.0 to 13.0 and preferably 6.5 to 9.0. Consequently, the alkaline substance is typically used in the solid food at a dry weight of 0.1 to 10% by weight (hereinafter to be simply abbreviated as %), and preferably 0.3 to 5%.

In this case, if the pH is lower than the above-mentioned range, the effect of improving food texture and yield is diminished, while if the pH is too high, flavor is impaired due to the generation of the characteristic bitter taste, pungency and odor of alkaline substances. In general, although fixed effects are demonstrated with the alkaline substance alone, in order to obtain favorable yield and food texture, it is necessary to maintain a high pH by using a highly concentrated alkaline agent, thereby resulting in the problem of the generation of bitter taste, pungency and odor. In addition, in the case of allowing the alkaline substance to act alone, since a reduction in yield and hardening of food texture proceed during storage, this is not suitable for foods premised on long-term storage. The amount of coating substance added is the amount within a range in which the surface structure of the food contracts, and the coating substance forms a coating by adhering at least to this surface portion as a result of being heated in the state of being in contact with the surface structure of the food. Consequently, the coating substance is typically used at a dry weight of 0.2 to 20%, and preferably 0.5 to 10%, based on the weight of the solid food. Furthermore, a “surface portion” refers to the surface and surface layer of the interior of a solid food. It is preferable in terms of imparting the desired function of maintaining food texture and improving storageability that a coating be formed as a result of the coating substance adhering to the surface portion of a food to a depth of about 1 mm or more from the surface portion.

Examples of methods for contacting the alkaline substance and coating substance with a solid food include tumbling, injection, immersion and powder adhesion. The solid is preferably held in contact with the alkaline substance and coating substance for a fixed period of time after being contacted thereby. For example, the solid food is immersed in a solution containing the two substances for 5 minutes or more at 0 to 30° C., and preferably immersed for 15 minutes or more for greater effects. In this case, however, the coating can be allowed to form immediately without immersing. The alkaline substance and coating substance may be contacted with the food in the form of a dry powder, or may be contacted after suitably dissolving into solution. In other words, any arbitrary configuration can be used which is capable of imparting the desired function of maintaining food texture and improving storageability of a food as a result of the alkaline and coating treatment of the present invention, including the form of the raw materials and the method of contact. In a mode in which a food is immersed in a solution, in the invention relating to treatment consisting of alkaline treatment only described in Japanese Patent Application Laid-open No. 2000-78957, for example, the food is immersed for 3 hours or more. In the present invention, however, the upper limit of the above-mentioned immersion time is about 30 minutes, and since the desired function of maintaining food texture and improving storageability can be imparted by immersing for about 5 to 15 minutes, the present invention is superior to the prior art in terms of being able to reduce detrimental effects on food in terms of the process and in terms of convenience.

Next, the following provides a more detailed explanation of the above-mentioned contact method. Contact treatment is preferably carried out such that the alkaline substance and coating substance are adhered to the surface of the solid food both thinly and uniformly. This is because, in the case of working the present invention, if the coating substance is coated thickly or unevenly, the inherent texture and flavor of the food may be impaired, and the coating substance is coated thinly and uniformly so as to be able to achieve the inherent texture and flavor of the food. In addition, contact treatment is preferably carried out in a state in which physical kneading effects are obtained by mixing, and more specifically, is preferably carried out by tumbling (kneader mixing) and so on since these methods are superior in the case of working the present invention industrially. As a result, the desired function of maintaining food texture and improving storageability of a food by the alkaline and coating treatment of the present invention can be satisfactorily imparted.

In addition, in the case of carrying out contact treatment using a solution containing the alkaline substance and coating substance, the food is preferably contacted with a solution at a comparatively high concentration. For example, the concentration of the alkaline substance in the mixed solution is 0.1 to 40%, the concentration of the coating substance (and particularly starch and so on) is 30 to 70%, and the proportion of water is preferably 30 to 70%. As a result, the alkaline substance and coating substance can be adhered thinly and uniformly, a processed food having the inherent texture and flavor of the food can be achieved, and the desired function of maintaining food texture and improving storageability of the food by the alkaline and coating treatment of the present invention can be satisfactorily imparted. These concentrations can also be used preferably in the case of obtaining the above-mentioned kneading effects. In the case of contacting the alkaline substance and coating substance with a food in the form of a dry powder, the effect of thinly and uniformly adhering the coating substance and the effect of kneading can be obtained. Contact by the alkaline substance and coating substance is preferably carried out in an atmosphere at normal pressure. In the case of carrying out this contact in an atmosphere under reduced pressure, the meat qualities and texture of the food may be impaired due to the excessive reduction in pressure, while also making the process susceptible to excessive complexity.

In the present invention, even greater function of maintaining food texture and improving storageability can be imparted by combining the use of an emulsifier. Examples of this emulsifier include glycerin fatty acid esters (such as those containing esters of monoglycerides or diglycerides and polycarboxylic acids), sucrose fatty acid esters, sorbitan fatty acid esters, propylene glycol fatty acid esters, lecithins and other nonionic emulsifiers, and particularly preferably succinic acid monoglycerides.

Next, an explanation is provided of the coating treatment. In the coating treatment, a solid food which has been contacted with the alkaline substance and the coating substance is exposed to hot water, steam, hot air, deep-frying or stir-frying and so on, and while the solid food contacted with the alkaline substance and coating substance on the surface thereof remains in this contacted state, the surface structure of the food shrinks, the coating substance thickens and adheres to that area, the food is placed in an atmosphere in which it is to be coated, and the surface of the food is coated by the coating substance. Although any arbitrary configuration can be used for the form and conditions of coating treatment provided the above-mentioned function is demonstrated, specific examples thereof are indicated below.

(1) A solid food such as meat contacted with the alkaline substance and a coating substance such as starch is placed in an atmosphere at a temperature equal to or higher than the temperature at which the meat protein denatures and the starch gelatinizes.

(2) A solid food subjected to contact treatment in the same manner as described above is filled into a container followed by the addition of a flavoring liquid and so on. In this case, the flavoring liquid is brought to a temperature equal to or higher than the above-mentioned temperature, and the meat protein is denatured while the starch is gelatinized as a result of being placed at that temperature. Alternatively, the flavoring liquid may be in the form of a highly viscous liquid (at any temperature), and container is sealed and this is then subjected to heat treatment to denature the meat protein and gelatinize the starch.

(3) A solid food subjected to contact treatment in the same manner as described above is mixed with a flavoring liquid and so on at a high temperature to denature the meat protein and gelatinize the starch followed by filling into a container. Alternatively, a solid food subjected to contact treatment is filled into a container after mixing with a highly viscous flavoring liquid, after which this is subjected to heat treatment to denature the meat protein and gelatinize the starch.

In methods (2) and (3) above, a highly viscous liquid refers to that having a viscosity of, for example, 300 mPa·s or more, and preferably 1000 to 30000 mPa·s.

(4) A solid food contacted with the alkaline substance and a comparatively large amount (for example, 10 to 20% of the dry weight of the solid food) of the coating substance may be mixed with a flavoring liquid at a temperature below the temperature at which the coating substance swells or at a higher temperature, followed by heating and coating. In the above methods, the surface of the solid food can be coated with the coating substance. In the above-mentioned cases, there are no particular limitations on the method, means or conditions of coating treatment provided coating can be achieved and the coating substance does not peel off, and can be selected or set arbitrarily. Furthermore, although the coating treatment can be carried out under temperature conditions at which the coating substance swells, coating is preferably carried out under conditions in which the solid food is at an ambient temperature of 80 to 250° C. in order to obtain even greater effects.

For example, in providing an explanation of the case of boiling using starch for the coating substance, it is necessary to place the solid food in hot water at a temperature equal to or higher than the gelatinization temperature of the starch (about 90° C.) when boiling. If the temperature is lower than this, since the starch which has contacted the solid food ends up dispersing in the hot water before gelatinizing during the course of boiling, it does not act on the solid food. Furthermore, coating treatment by boiling in this manner may also serve to eliminate any harsh taste and odor of the meat.

In addition, the number of microorganisms present in a solid food can be reduced by contact treatment such as boiling, thereby suppressing microbial contamination of the production line. In addition, although weighing meat with an automated scale is difficult thereby requiring weighing to be performed manually since meat prior to processing demonstrates strong mutual adhesiveness, boiling makes weighing easier thereby improving productivity. In the present invention, contact treatment is not limited to boiling, but rather other heating methods can also be used as is suitable.

Next, an explanation is provided of heat treatment. Although the significance of heat treatment is as previously described, the conditions of heat treatment consist of conditions equivalent to or more than a temperature of 80° C. for 15 minutes for heating a solid food. Preferably, heat treatment is carried out at 80 to 135° C. for about 15 minutes to 20 hours, and in the case of chilled foods, for example, under conditions equivalent to or more than 105° C. for 15 minutes, in the case of pre-cooked foods, under conditions equivalent to or more than 122° C. for 20 minutes, and in the case of sterile filled foods, under conditions equivalent to or more than 130° C. for 10 minutes, thereby enabling heat treatment to also serve as sterilization treatment. As a result of this heat treatment, the food itself can be consumed since softening of the solid food progresses, and the solid food can be preferably used as an ingredient of pre-cooked and chilled products. However, the softness of the food texture is inadequate unless this treatment is carried out. In the case of preparing these foods by treating with an alkaline agent alone, it is necessary to raise the pH using a highly concentration alkaline agent in order to obtain satisfactory yield and texture, and as a result, there is the problem of the generation of bitter taste, pungency and an alkaline odor. In the present invention, however, these problems can be avoided due to interaction between the above-mentioned coating and heating treatment. Furthermore, the above-mentioned “conditions equivalent to or more than a temperature of 80° C. for 15 minutes” refers to heat treatment under conditions of 80° C. or higher and of the time or more for which the amount of time required for heating is equivalent to 80° C. for 15 minutes, for all as ambient temperatures. Specific examples of which include conditions equivalent to or more than a temperature of 80° C. to less than 100° C. for 15 minutes, conditions equivalent to or more than a temperature of 100° C. to less than 120° C. for 10 minutes, and conditions equivalent to or more than a temperature of 120° C. for 5 minutes. The description of “after placing in boiling water and boiling for 5 minutes” in Comparative Examples 6-1 and 6-2 does not apply to the heat treatment as referred to in the present invention.

In the present invention, since adequate texture improvement effects are obtained with only a small amount of alkaline substance depending on the combination of alkaline substance, coating substance, coating treatment and heat treatment, generation of negative qualities of the alkaline substance in the form of bitter taste, pungency and alkaline odor can be reduced.

In the present invention, the following treatment steps are important, and the prescribed function is thought to be achieved as a result thereof. These are (a) a pretreatment step in which two substances consisting of an alkaline substance and a coating substance are adhered to the surface of a solid food, and (b) a coating step in which the coating substance is melted by subjecting the solid food to heat treatment by placing in the atmosphere described above, and allowed to infiltrate the surface or surface and interior of the solid food and thicken to coat the surface of the solid food. The alkaline substance breaks down muscle fibers to assist in penetration of the coating substance. In the present invention, the above-mentioned action can be reliably demonstrated without loss of activity by the coating substance in a heating median and so on. Heat treatment is essential for heating and denaturing the solid food and softening into a palatable state. Although creating a palatable state, this heat treatment conventionally tended to cause denaturing to proceed causing the solid food to become excessively hard. In the present invention, however, since the coating retains the alkaline substance during heating, the alkaline substance penetrates the meat on the inside of the film, and the function of breaking down muscle fibers continues resulting in improved moisture retention. In addition, this function continues during distribution and storage following the completion of heat treatment.

In the present invention, a food like that described above or a pre-cooked food or chilled food containing the food as an ingredient thereof can be prepared. In general, foods are damaged by treatment heat during heat sterilization for product storage. In addition, meats are subjected to changes in the pH balance of the alkaline substance during storage. A function of the present invention is to coat a solid food with a coating so as to prevent overheating and physical stimulation during heat treatment while at the same time allowing the coating to maintain alkaline properties, allowing the alkaline properties to penetrate into the solid food inside the film and sustain the function of breaking down muscle fibers and so on. In addition, the film maintains alkaline properties during storage as well, there is little change in the pH balance between the solid food and the soup, thereby enabling the texture to be maintained until the time of consumption. In particular, this coating retention action maintains alkaline properties during coating treatment and heat treatment for product storage simply by treating the surface with the alkaline substance, resulting in penetration to the interior of the food to act to maintain food texture. Thus, greater effects are demonstrated by adding only a small amount of alkaline substance as compared with alkaline treatment alone, and these effects do not impair flavor. Furthermore, there are no particular limitations on the form of the finished products of processed solid foods (including foods in which they are contained) provided the desired function of the present invention is demonstrated, and may be in the form of frozen foods and so on. In the case of frozen foods, the effect is obtained by which there is little dripping when thawing the food, and the quality of the solid food, as well as the entire food in which it is combined with other foods, is maintained.

In the present invention, solid foods, and in particular meat or seafood, can be identified as to whether or not they have undergone coating treatment after having been contacted with starch in advance by using the method described below. In the case of this treatment, namely carrying out heat treatment after having mixed a solid food with starch in advance, starch can be confirmed to have infiltrated inside the solid food. In the case of cutting an untreated food and a processed food subjected to this treatment with a knife and so on, and dropping iodine onto the resulting cross-section, in contrast to a violet color being unable to be confirmed in the absence of treatment, the presentation of a violet color can be confirmed in the interior (near the surface layer) of a treated food. Furthermore, similar confirmation can be made for coating substances other than starch by using a coloring agent suitable thereto.

In food forms in which the solid portion and liquid portion of a solid food are both present and starch is contained in the liquid portion (such as in the case of curry sauce), in the case of iodine dyeing after having rinsed the solid food with water, although treated pieces and untreated pieces are observed to be colored in the surface portion of the solid food, in the case of cutting meat or seafood with a knife and dropping iodine onto the resulting cross-section, in contrast to coloring not being able to be confirmed in the interior (near the surface layer), the presentation of a violet color can be confirmed in the interior (near the surface layer) of a treated food.

Moreover, in the present invention, since myoglobin present in meat and so on subjected to alkaline treatment is discolored due to the high pH, it typically presents a reddish-black color. In addition, in the case of a difference in pH between the liquid and solid food, although the pH gradually becomes homogeneous during storage following production, there is a considerable difference in the rate thereof between (1) the case in which the present invention is worked using an alkaline substance, and (2) the case of not using an alkaline substance. In the case of (2) above, when boiled meat is filled with curry sauce followed by pre-cooking sterilization and storage at room temperature, the pH of the sauce and meat pieces become equal in about 1 week. In contrast, in the case of (1) above, when meat is boiled and treated in the same manner, the initial difference in pH between the meat pieces and sauce is maintained even after about 1 month of storage.

Since foods like those described above can also serve as foods for persons with so-called depressed swallowing or chewing function, an explanation is provided of this form of food achieved by the present invention. Here, the term “food for persons with depressed swallowing or chewing function” refers to a food which can be easily chewed or is not required to be chewed, and which can be swallowed easily. Since adequately softened, ordinarily cut natural meats were not available in the past for use as heat-treated meats contained in these types of foods, substitutes were used which were prepared by breaking the meat up into small fragments by grinding and so on, pressing the ground meat together with a mold, and then cooking appropriately. However, these artificial meats were not satisfactory in terms of texture, flavor or appearance, thus resulting in a need to provide adequately softened cuts of natural meats for persons with depressed chewing or swallowing function. The present invention is able to provide meats and other solid foods which respond to this need as well as processed heated foods containing these solid foods therein.

In other words, these foods themselves, or solid foods in which they are contained, are processed solid foods in which texture is maintained and which are imparted with softening action and storageability by heat treatment, are not subjected to pressing treatment, and are processed solid foods for persons with depressed chewing or swallowing function having a volume in the case of the above-mentioned meats such that the swallowing index in the form of maximum stress is 5×10⁴ N/m² or less, and preferably 2×10⁴ to 4×10⁴ N/m² and a pH of 6 to 7. Preferable examples of these foods include meats, and particularly red meat. In addition, in boiled foods such as simmered meat and potato in which meats are left to appear as is in consideration of appearance, the appearance is favorable and such foods have higher quality as a food for the above-mentioned application.

Furthermore, the method for measuring “maximum stress” is described below. The measuring instrument used is an instrument capable of measuring the compressive stress of a substance by linear movement, an example of which is the Sun Rheometer (CR-500DX) manufactured by Sun Chemical Industry Co., Ltd. The plunger which enters the sample is made of plastic and has a cylindrical shape having a diameter of 20 mm. After placing the sample on a measuring stand, the plunger is pressed into the sample at a compression rate of 10 mm/sec to a distance from the measurement stand to the plunger of 5 mm. The location where the plunger enters the sample is the center of the sample, and a single measurement is performed on a single sample. The measuring temperature is 20° C.±2° C. Measurements are performed on five samples. The average value of three of the measured values, after excluding the maximum and minimum values from the five measured values, is determined and used as the measured value for that sample.

A processed solid food of the present invention can be used as a universal design food. A universal design food refers to food for persons requiring nursing care that is easy to chew and swallow even for persons having difficulty in chewing or swallowing as certified by the Japan Care Food Conference, and is classified into grade 1 (easily bitten into), grade 2 (crushable with gums), grade 3 (crushable with tongue) and grade 4 (chewing not required). Foods of the present invention are particularly useful in the case of providing foods of grade 2.

In addition, in the present invention, frozen foods can be provided for raw materials and so on by causing heat denaturation of protein in the food in the state of contacting the surface with an alkaline substance and coating substance as previously described, and freezing a solid food by subjecting the surface to coating treatment with the coating substance by placing in an atmosphere at a temperature equal to or higher than the temperature at which the coating substance forms a film. Namely, the above-mentioned food is able to demonstrate the desired function of the present invention of maintaining food texture and improving storageability by carrying out the above-mentioned heat treatment after frozen storage. In addition, the above-mentioned food has the effect of reducing dripping during thawing. The conditions for freezing are arbitrary, and the above-mentioned action is obtained provided a solid food is frozen after being subjected to coating treatment.

Moreover, in the present invention, a food containing a solid food and a liquid comprises a food combining a liquid with a solid food treated by combining the alkaline substance, coating substance, coating treatment and heat treatment of the present invention. In particular, this food can also be composed by carrying out heat treatment by sterilization treatment such as pre-cooking sterilization treatment. In this case, a liquid food having a weakly acidic to neutral pH, such as a pH of 3.5 to 7.0, is used for the liquid. Namely, although flavor is affected if heat treatment is carried out under conditions of a pH higher than the pH of a solid food in the case of working the present invention with a solid food alone, if a liquid having a weakly acidic to neutral pH is present at that time, the effect is diminished while at the same time, as a result of maintaining the difference between the pH of the solid food and the pH of the liquid during storage as previously described, the desired function of the present invention of maintaining food texture and improving storageability can be achieved more preferably. There are no limitations on the type of food for the liquid, and stews, curries, brown sauces and other sauces, boiled flavored liquids, and sauces for steak and so on are used preferably. There are no particular limitations on the viscosity of the liquid, and the use of a highly viscous liquid as previously described enables the liquid to function in coating treatment. There are also no particular limitations on the ratio between the solid food and liquid, and the use of 5 to 99% liquid to 1 to 95% solid food is preferable in terms of obtaining the desired function of the present invention. Foods containing solid food and liquid can be composed in the form of chilled foods, pre-cooked foods and so on.

The following effects are exhibited by the present invention.

(1) A solid food such as meat or seafood, having superior storageability and for which quality does not decrease even when stored for a long period of time, a cooked food using this solid food as an ingredient thereof, and a method for producing the same can be provided.

(2) A class 2 universal design food as certified by the Japan Care Food Conference can be prepared according to the method for producing cooked foods.

(3) A food containing the solid food and a liquid can be produced and provided.

(4) Processed meat can be produced and provided for which the soft texture of meat or seafood is stably maintained and quality does not decrease even when stored for intermediate or long periods of time by contacting an alkaline substance and a coating substance with the surface of a solid food and carrying out coating treatment and heat treatment.

### BRIEF DESCRIPTION OF THE DRAWINGS

FIG. 1 shows a schematic drawing of a piercing device provided with two rollers, having blades provided in a ring shape around the periphery of each, aligned in the axial direction above and below in mutual opposition, as viewed from the front side (vertical direction);

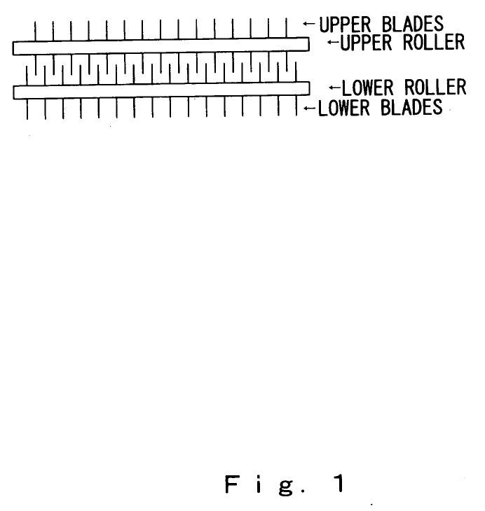

FIG. 2 shows the degree of piercing of the piercing blades;

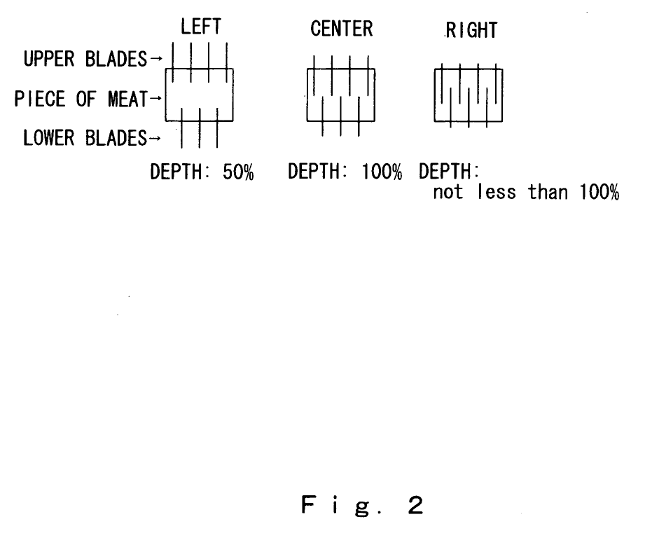

FIG. 3 schematically shows the state in which the interval in the vertical direction of the piercing blades has been adjusted to about 0 mm;

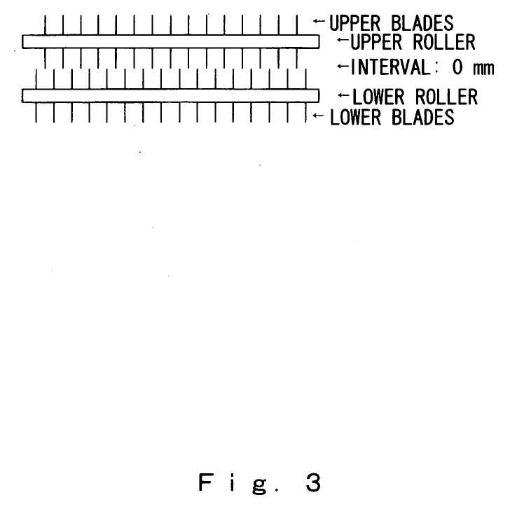

FIG. 4 shows an example of piercing blades of a device used in the examples; and

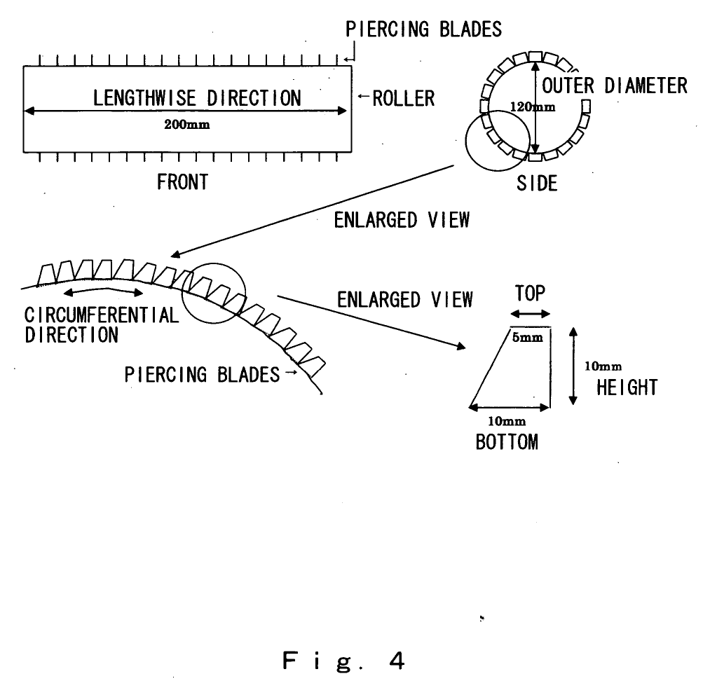

FIG. 5 shows a cross-sectional photograph taken after staining products obtained in Comparative Example 1 and Example 3 on which heat sterilization treatment was carried out.

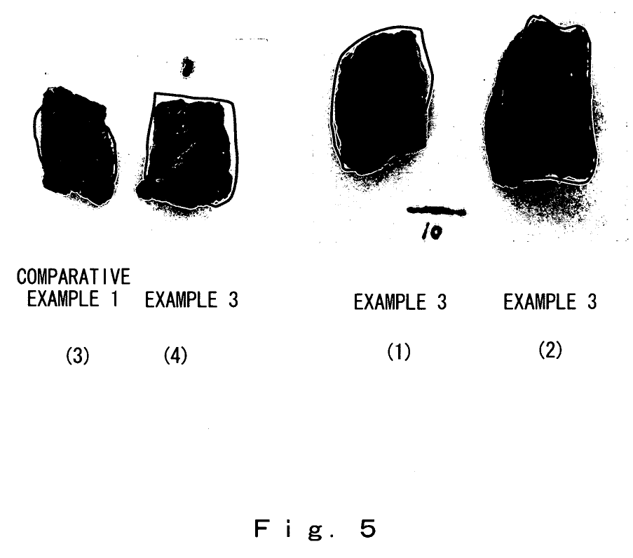

### DESCRIPTION OF THE PREFERRED EMBODIMENTS

The following provides a detailed explanation of the present invention based on examples and comparative examples thereof.

### COMPARATIVE EXAMPLE 1

(No Treatment, Boiling)

1 kg of beef was cut into bite-size pieces measuring 18 mm×18 mm×7 mm and having a volume of about 2268 mm³ (to apply similarly hereinafter). The beef was placed in boiling water, and after boiling for 5 minutes, was cooled in water at 20° C. 30 g of this beef was then filled into a pre-cooked food retort pouch followed by the addition of 170 g of curry sauce, and after sealing the pouch to be airtight, was pre-cooked by pressurized heat sterilization treatment for 25 minutes at 122° C.

### COMPARATIVE EXAMPLE 2-1

(Low Alkaline Concentration, No Starch, No Coating)

1 kg of beef was cut into bite-size pieces. This was then immersed for 4 hours in a 1% sodium bicarbonate solution. The meat was removed and strained with a strainer. After then placing in boiling water and boiling for 5 minutes, the meat was cooled in water at 20° C. 30 g of this were then filled into a pre-cooked food retort pouch followed by the addition of 170 g of curry sauce, and after sealing the pouch to be airtight, was pre-cooked by pressurized heat sterilization treatment for 25 minutes at 122° C.

### COMPARATIVE EXAMPLE 2-2

(High Alkaline Concentration, No Starch, No Coating)

1 kg of beef was cut into bite-size pieces. This was then immersed for 4 hours in a 4% sodium bicarbonate solution. The meat was removed and strained with a strainer. After then placing in boiling water and boiling for 5 minutes, the meat was cooled in water at 20° C. 30 g of this were then filled into a pre-cooked food retort pouch followed by the addition of 170 g of curry sauce, and after sealing the pouch to be airtight, was pre-cooked by pressurized heat sterilization treatment for 25 minutes at 122° C.

### COMPARATIVE EXAMPLE 3

(Starch Only, No Alkali)

1 kg of beef was cut into bite-size pieces. 25 g of potato starch were added and mixed to uniformly adhered to the surface of the meat. After then placing in boiling water and boiling for 5 minutes, the meat was cooled in water at 20° C. 30 g of this were then filled into a pre-cooked food retort pouch followed by the addition of 170 g of curry sauce, and after sealing the pouch to be airtight, was pre-cooked by pressurized heat sterilization treatment for 25 minutes at 122° C.

### COMPARATIVE EXAMPLE 4

(Alkali+Starch, No Coating=No Boiling)

1 kg of beef was cut into bite-size pieces. 6 g of sodium bicarbonate and 25 g of potato starch were added and mixed to uniformly adhere to the surface of the meat. 30 g of this were then filled into a pre-cooked food retort pouch followed by the addition of 170 g of curry sauce having a temperature of 25° C. and having a viscosity of 5 mPa·s at the same temperature, and after sealing the pouch to be airtight, was pre-cooked by pressurized heat sterilization treatment for 25 minutes at 122° C.

### COMPARATIVE EXAMPLE 5

(Alkali+Starch, No Coating=Boiling From Water)

1 kg of beef was cut into bite-size pieces. 6 g of sodium bicarbonate and 25 g of potato starch were added and mixed to uniformly adhered to the surface of the meat. This was then placed in water and then heated followed by boiling for 5 minutes after the water boiled and cooling in water at 20° C. 30 g of this were then filled into a pre-cooked food pouch followed by the addition of 170 g of curry sauce, and after sealing the pouch to be airghtight, was pre-cooked by pressurized heat sterilization treatment for 25 minutes at 122° C.

### COMPARATIVE EXAMPLE 6-1

(Alkali+Starch, Coating, No Heat Treatment)

1 kg of beef was cut into bite-size pieces. 6 9 of sodium bicarbonate and 25 g of potato starch were added and mixed to uniformly adhere to the surface of the meat. This was then placed in boiling water to boil it for 5 minutes, and then was cooled in water at 20° C.

### COMPARATIVE EXAMPLE 6-2

(Alkali+Starch, Coating, No Heat Treatment)

1 kg of beef was cut into bite-size pieces. 24 g of sodium bicarbonate and 25 g of potato starch were added and mixed to uniformly adhere to the surface of the meat. This was then placed in boiling water to boil it for 5 minutes, and then was cooled in water at 20° C.

### EXAMPLE 1

Chilled Curry of Present Invention, Coating=Boiling, Coating Substance=Potato Starch)

1 kg of beef was cut into bite-size pieces. 6 g of sodium bicarbonate and 25 g of potato starch were added and mixed to uniformly adhere to the surface of the meat. This was then placed in boiling water followed by boiling for 5 minutes and cooling in water at 20° C. 30 g of this were then filled into a pre-cooked food retort pouch followed by the addition of 170 g of curry sauce, and after sealing the pouch to be airtight, was pre-cooked by heating for 35 minutes at 105° C. (pressurized heat sterilization treatment).

### EXAMPLE 2

(Chilled Curry of Present Invention, Coating=Boiling, Coating Substance=Potato Starch)

1 kg of beef was cut into bite-size pieces. 6 g of sodium bicarbonate and 25 g of potato starch were added and mixed to uniformly adhere to the surface of the meat. This was then placed in boiling water followed by boiling for 5 minutes and cooling in water at 20° C. 30 g of this were then filled into a pre-cooked food retort pouch followed by the addition of 170 g of curry sauce, and after sealing the pouch to be airtight, was pre-cooked by heating for 3 hours at 95° C. (sterilization)

### EXAMPLE 3

(Pre-Cooked Retort Curry of Present Invention, Coating=Boiling, Coating Substance=Potato Starch)

1 kg of beef was cut into bite-size pieces. 6 g of sodium bicarbonate and 25 g of potato starch were added and mixed to uniformly adhere to the surface of the meat. This was then placed in boiling water followed by boiling for 5 minutes and cooling in water at 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment).

### EXAMPLE 4

(Pre-Cooked Retort Curry of Present Invention, Coating=Baking, Coating Substance=Potato Starch)

1 kg of beef was cut into bite-size pieces. 6 g of sodium bicarbonate and 25 g of potato starch were added and mixed to uniformly adhere to the surface of the meat. This was then baked in an oven for 5 minutes at 220° C. followed by cooling to 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment).

### EXAMPLE 5

(Pre-Cooked Retort Curry of Present Invention, Coating=Steaming, Coating Substance=Potato Starch)

1 kg of beef was cut into bite-size pieces. 6 g of sodium bicarbonate and 25 g of potato starch were added and mixed to uniformly adhere to the surface of the meat. This was then steamed with a steamer for 5 minutes followed by cooling to 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment).

### EXAMPLE 6

(Pre-Cooked Retort Curry of Present Invention, Coating=Deep-Frying, Coating Substance=Potato Starch)

1 kg of beef was cut into bite-size pieces. 6 g of sodium bicarbonate and 25 g of potato starch were added and mixed to uniformly adhere to the surface of the meat. This was then deep-fried at 130° C. followed by cooling to 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment).

### EXAMPLE 7

(Pre-Cooked Retort Curry of Present Invention, Coating=Stir-Frying, Coating Substance=Potato Starch)

1 kg of beef was cut into bite-size pieces. 6 g of sodium bicarbonate and 25 g of potato starch were added and mixed to uniformly adhere to the surface of the meat. This was then stir-fried in a frying pan followed by cooling to 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment). Furthermore, the curry sauce filled into a pre-cooked food retort pouch in each of the above comparative examples (excluding Comparative Example 4) and examples had a temperature of 90° C. and a viscosity at the same temperature of 2600 mPa·s.

### EXAMPLE 8

(Pre-Cooked Retort Curry of Present Invention, Coating=Heating by High-Temperature Curry Sauce)

1 kg of beef was cut into bite-size pieces. 6 g of sodium bicarbonate and 25 g of potato starch were added and mixed to uniformly adhere to the surface of the meat. 30 g of this were then filled into a pre-cooked food retort pouch followed by the addition of 170 g of curry sauce having a temperature of 90° C. and having a viscosity of 2 mPa·s at the same temperature, and after sealing the pouch to be airtight, was pre-cooked by heating for 25 minutes at 122° C. (pressurized heat sterilization treatment).

### EXAMPLE 9

(Pre-Cooked Retort Curry of Present Invention, Coating=Heating Separate From Low-Temperature, High-Viscosity Curry Sauce)

1 kg of beef was cut into bite-size pieces. 6 g of sodium bicarbonate and 25 g of potato starch were added and mixed to uniformly adhere to the surface of the meat. 30 g of this were then filled into a pre-cooked food retort pouch followed by the addition of 170 g of curry sauce having a temperature of 25° C. and having a viscosity of 8400 mPa·s at the same temperature, and after sealing the pouch to be airtight, was pre-cooked by heating for 25 minutes at 122° C. (pressurized heat sterilization treatment).

### EXAMPLE 10

(Pre-Cooked Retort Curry of Present Invention, Coating=Heating by High-Temperature, High-Viscosity Curry Sauce)

1 kg of beef was cut into bite-size pieces. 6 g of sodium bicarbonate and 25 g of potato starch were added and mixed to uniformly adhere to the surface of the meat. 30 g of this were then filled into a pre-cooked food retort pouch followed by the addition of 170 g of curry sauce having a temperature of 90° C. and having a viscosity of 2600 mPa·s at the same temperature, and after sealing the pouch to be airtight, was pre-cooked by heating for 25 minutes at 122° C. (pressurized heat sterilization treatment).

### EXAMPLE 11

(Pre-Cooked Retort Curry of Present Invention, Coating=Separate Heating After Mixing with Low-Temperature, High-Viscosity Curry Sauce)

1 kg of beef was cut into bite-size pieces. 6 g of sodium bicarbonate and 25 g of potato starch were added and mixed to uniformly adhere to the surface of the meat. This was then mixed with 170 g of a curry sauce having a temperature of 25° C. and having a viscosity of 8400 mPa·s at the same temperature, and after sealing the pouch to be airtight, was pre-cooked by heating for 25 minutes at 122° C. (pressurized heat sterilization treatment).

### EXAMPLE 12

(Pre-Cooked Retort Meat of Present Invention, Coating=Boiling)

50 g of the beef cooled in water in Comparative Example 6-1 were filled into a pre-cooked food retort pouch, and after sealing the pouch to be airtight, was pre-cooked by heating for 25 minutes at 122° C. (pressurized heat sterilization treatment).

### COMPARATIVE EXAMPLE 7

(No Treatment, Boiling)

1 kg of beef was cut into bite-size pieces. This was then placed in boiling water, and after boiling for 5 minutes, was cooled in water at 20° C. 12 g of this meat was then filled into a pre-cooked food retort pouch followed by the addition of 48 g of vegetables consisting of potatoes, carrots and green peas, and 40 g of sauce, and after sealing the pouch to be airtight, was pre-cooked by heating for 19 minutes at 122° C. (pressurized heat sterilization treatment) to prepare a simmered meat and potato.

### EXAMPLE 13

(Pre-Cooked Retort Meat and Potatoes Simmered and Potato of Present Invention, Coating=Boiling)

1 kg of beef was cut into bite-size pieces. A mixture of 36 g of sodium bicarbonate, 25 g of potato starch and 60 g of water was added to uniformly adhere to the surface of the meat. This was then placed in boiling water, and after boiling for 5 minutes, was cooled in water at 200° C. 12 g of this were then filled into a pre-cooked food retort pouch followed by the addition of 48 g of vegetables consisting of potatoes, carrots and green peas, and 40 g of sauce, and after sealing the pouch to be airtight, was pre-cooked by heating for 19 minutes at 122° C. (pressurized heat sterilization treatment) to prepare a simmered meat and potato.

### EXAMPLE 14

(Pre-Cooked Retort Meat and Potatoes Simmered of Present Invention, Coating=Boiling)

1 kg of beef was cut into bite-size pieces. A mixture of 6 g of sodium bicarbonate, 25 g of potato starch and 60 g of water was added to uniformly adhere to the surface of the meat. This was then placed in boiling water, and after boiling for 5 minutes, was cooled in water at 20° C. 12 g of this were then filled into a pre-cooked food pouch followed by the addition of 48 g of vegetables consisting of potatoes, carrots and green peas, and 40 g of sauce, and after sealing the pouch to be airtight, was pre-cooked by heating for 19 minutes at 122° C. (pressurized heat sterilization treatment) to prepare a simmered meat and potato.

### EXAMPLE 15

(Pork and Radish Boil of Present Invention, Coating=Boiling)

1 kg of pork was cut into bite-size pieces measuring 25 mm×25 mm×7 mm and having a volume of about 4375 mm³. A mixture of 10 g of sodium bicarbonate, 50 g of potato starch and 100 g of water was added to uniformly adhere to the surface of the meat. This was then placed in boiling water, and after boiling for 5 minutes, was cooled in water at 20° C. 12 g of this were then filled into a pre-cooked food retort pouch followed by the addition of 50 g of radish and 35 g of sauce, and after sealing the pouch to be airtight, was pre-cooked by heating for 19 minutes at 122° C. (pressurized heat sterilization treatment) to prepare a pork and radish boil.

### EXAMPLE 16

(Pre-Cooked Retort Curry of Present Invention, Coating=Boiling, Coating Substance=Potato Starch)

1 kg of beef was cut into bite-size pieces. 6 g of sodium bicarbonate and 50 g of potato starch were added and mixed to uniformly adhere to the surface of the meat. This was then placed in boiling water, and after boiling for 5 minutes, was cooled in water at 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment).

### EXAMPLE 17

(Pre-Cooked Retort Curry of Present Invention, Coating Boiling, Coating Substance=Cornstarch)

1 kg of beef was cut into bite-size pieces. 6 g of sodium bicarbonate and 50 g of cornstarch were added and mixed to uniformly adhere to the surface of the meat. This was then placed in boiling water, and after boiling for 5 minutes, was cooled in water at 20° C. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment). In this case, the pH on the surface of the beef after the boiling was about 6.9 and the pH of the curry sauce was about 5.0, while the pH on the surface of the beef after pre-cooking heat treatment was about 5.9 and the pH of the curry sauce was about 5.1. Furthermore, the pH of the curry sauce used in the other examples and comparative examples were similarly about 5.0.

### EXAMPLE 18

(Pre-Cooked Retort Curry of Present Invention, Coating=Low Temperature→High Temperature, Coating Substance=Cornstarch)

1 kg of beef was cut into bite-size pieces. 6 g of sodium bicarbonate and 100 g of cornstarch were added and mixed to uniformly adhere to the surface of the meat. This was then placed in hot water at 50° C. and then heated to 85° C., and after boiling for 5 minutes, was cooled in water at 20° C. 30 g of this were then filled into a pre-cooked food pouch followed by the addition of 170 g of curry sauce, and after sealing the pouch to be airtight, was pre-cooked by heating for 25 minutes at 122° C. (pressurized heat sterilization treatment).

### EXAMPLE 19

(Frozen Food of Present Invention)

After boiling as in Example 1 and cooling in water, beef was filled into a pouch and frozen. After storing frozen for 5 days at −18° C., the frozen meat was thawed at room temperature. There was little dripping during thawing. 30 g of this were then filled into a pre-cooked food retort pouch followed by the addition of 170 g of curry sauce, and after sealing the pouch to be airtight, was pre-cooked by heating for 25 minutes at 122° C. (pressurized heat sterilization treatment).

(1) Storage Test

A storage test was conducted on each of the above samples. The method consisted of conducting a severe test consisting of storing for 20 days at 50° C. (equivalent to storing for about 4 months at room temperature).

(2) Evaluation

The meats composing the above-mentioned products subjected to each of the treatments described above were evaluated according to the criteria indicated below. Namely, products immediately after production for Comparative Examples 6-1 and 6-2, products stored for 1 day and products stored for 1 month at 5° C. for Examples 1 and 2, products on the day after production and products following the above-mentioned storage test for Comparative Example 1 to 5 and Examples 3 to 12 and 16, and products on the day after production for Comparative Example 7 and Examples 13 to 15 were evaluated.

(Texture and Flavor)

Meats composing products immediately after production, after frozen storage for 1 day, or on the day after heat sterilization treatment (indicated as “Immediately After Production” in Table 1), and meats composing products after storing for 1 month or products following the above-mentioned storage test (indicated as “After Storage” in Table 1), were respectively boiled for 5 minutes in boiling water and then eaten by ten panelists. The averages of the values resulting from evaluation of texture and flavor based on the following five ranks are shown in Table 1 after rounding to the nearest integer.

Texture (Softness, Juiciness)
1: Very hard and dry, no juiciness whatsoever
2: Hard and dry, and hardly any juiciness
3: Somewhat hard and difficult to chew, and only slightly juicy
4: Soft, easy to chew and juicy
5: Extremely soft and easy to chew and very juicy and moist

Flavor (Taste, Aroma)
1: No retention of meat juices and no meat flavor, or strong alkaline odor and poor taste
2: Little retention of meat juices and weak meat flavor, or somewhat alkaline odor and unpleasant taste
3: No alkaline odor but somewhat weak meat flavor
4: Somewhat rich in meat juices and definite meat flavor
5: Rich in meat juices and delicious meat flavor

Furthermore, since flavor consisted of that resulting from the meat and that imparted by the alkaline agent, ranks 1, 2 and 3 are shown in combination.

TABLE 1

| | |
|---|---|
| Immediately | |
| After Production | After Storage |

| | Texture | Flavor | Texture | Flavor |
|---|---|---|---|---|
| Comp. Ex. 1 | 1 | 2 | 1 | 1 |
| Comp. Ex. | 3 | 3 | 2 | 2 |
| 2-1 | | | | |
| Comp. Ex. | 5 | 1 | 3 | 1 |
| 2-2 | | | | |
| Comp. Ex. 3 | 3 | 4 | 2 | 3 |
| Comp. Ex. 4 | 3 | 4 | 3 | 3 |
| Comp. Ex. 5 | 3 | 4 | 2 | 3 |
| Comp. Ex. | 2 | 2 | — | — |
| 6-1 | | | | |
| Comp. Ex. | 3 | 1 | — | — |
| 6-2 | | | | |
| Comp. Ex. 7 | 1 | 2 | — | — |
| Example 1 | 5 | 5 | 5 | 5 |
| Example 2 | 5 | 5 | 4 | 5 |
| Example 3 | 5 | 5 | 5 | 5 |
| Example 4 | 4 | 5 | 4 | 5 |
| Example 5 | 5 | 5 | 5 | 5 |
| Example 6 | 4 | 5 | 4 | 5 |
| Example 7 | 4 | 5 | 4 | 5 |
| Example 8 | 4 | 4 | 4 | 4 |
| Example 9 | 4 | 5 | 4 | 5 |
| Example 10 | 5 | 5 | 5 | 5 |
| Example 11 | 4 | 5 | 4 | 5 |
| Example 12 | 5 | 4 | 5 | 4 |
| Example 13 | 5 | 3 | — | — |
| Example 14 | 4 | 5 | — | — |
| Example 15 | 5 | 4 | — | — |
| Example 16 | 5 | 5 | 5 | 5 |
| Example 17 | 5 | 5 | 5 | 5 |
| Example 18 | 4 | 4 | 4 | 4 |
| Example 19 | 4 | 4 | 4 | 4 |
| Example 20 | 5 | 5 | 5 | 5 |
| Example 21 | 5 | 5 | 5 | 5 |

(Yield)

Moreover, the yields as measured using the method described below for meats composing a portion of each of the products are shown in Table 2. Total yield (ratio of weight after heat sterilization treatment to raw material weight) was calculated by multiplying the coating treatment yield (ratio of the weight after coating treatment to raw material weight) by the heat sterilization treatment yield (ratio of the weight after heat sterilization treatment to weight after coating treatment) using the following equations (1) to (3) for all of the comparative examples except Comparative Example 4 and Examples 1 to 7 and 12. Furthermore, the coating treatment yield was indicated for the yield for Comparative Examples 6-1 and 6-2.
Coating treatment yield (%)=weight after coating treatment (g)÷raw material weight (g)×100 (1)
Heat sterilization treatment yield (%)=weight after heat sterilization treatment (g)−weight after coating treatment (g)×100 (2)
Yield (%)=coating treatment yield (%)×heat sterilization treatment yield (%)÷100 (3)

Yield was calculated from raw material weight and weight after heat sterilization treatment using the following equation (4) for Comparative Example 4 and Examples 8 to 11.
Yield (%)=weight after heat sterilization
treatment (g)÷raw material weight (g)×100 (4)

Furthermore, raw material weight refers to the weight of red meat or other solid food, and does not include the weight of the alkaline agent, coating substance and so on. Together therewith, weight after coating treatment was measured by cooling the solid food following coating treatment in water at 20° C. followed by draining off the water with a strainer having openings of about 2 mm and weighing. In addition, weight after heat sterilization treatment was measured by boiling the product in boiling water for 5 minutes, opening the pre-cooked food pouch, straining the contents with a strainer having openings of about 2 mm, and completely rinsing off the sauce with hot water at 40° C. followed by taking out the solid food and weighing.

TABLE 2

Yield (%)

| | Immediately After | |
|---|---|---|
| | Production | After Storage |
| Comparative | 60 | 53 |
| Example 1 | | |
| Comparative | 61 | 58 |
| Example 2-1 | | |
| Comparative | 78 | 67 |
| Example 2-2 | | |
| Comparative | 71 | — |
| Example 3 | | |
| Comparative | 72 | — |
| Example 4 | | |
| Comparative | 73 | — |
| Example 5 | | |
| Comparative | 90 | — |
| Example 6-1 | | |
| Comparative | 106 | — |
| Example 6-2 | | |
| Example 1 | 83 | — |
| Example 2 | 84 | — |
| Example 3 | 80 | 79 |
| Example 4 | 86 | — |
| Example 5 | 89 | — |
| Example 6 | 87 | — |
| Example 7 | 90 | — |
| Example 8 | 75 | — |
| Example 9 | 85 | — |
| Example 10 | 88 | — |
| Example 11 | 80 | — |
| Example 12 | 79 | — |
| Example 16 | 85 | — |
| Example 17 | 91 | — |
| Example 18 | 91 | — |
| Example 19 | 77 | — |
| Example 20 | 79 | — |
| Example 21 | 86 | — |

(Maximum Stress)

Maximum stress (units:×10⁴ (N/m²)) as measured using the measurement method described below is shown in Table 3 for meat composing products on the day after heat sterilization treatment obtained in Comparative Examples 1 and 7 and Examples 3, 13, 14 and 15.

TABLE 3

| | Maximum Stress (×10⁴ (N/m²)) |
|---|---|
| Comparative Example 1 | 5.08 |
| Example 3 | 2.98 |
| Comparative Example 7 | 5.08 |
| Example 13 | 2.70 |
| Example 14 | 3.90 |

(Cross-Sectional Photograph)

Cross-sectional photographs are shown which were taken after staining using the previously described staining method the meat composing products on the day after heat sterilization treatment obtained in Comparative Example 1 and Example 3. More specifically, after opening the pre-cooked food pouch, straining the contents with a strainer having openings of about 2 mm and completely rinsing off the sauce with hot water at 40° C., the solid food was taken out and cut with a knife followed by dropping a 0.05 mol/L iodine solution (Wako Pure Chemical Industries) onto the cross-sectional surface and immediately photographing the cross-section. The corresponding numbers of the photographs are shown in Table 4.

TABLE 4

Photograph Numbers

| | Immediately After | |
|---|---|---|
| | Production | After Storage |
| Comparative | — | (3) |
| Example 1 | | |
| Example 3 | (1), (2) | (4) |

### EXAMPLE 20

(Alkaline Agent=Trisodium Citrate)

1 kg of beef was cut into bite-size pieces. 20 g of trisodium citrate and 40 g of cornstarch were added and mixed to uniformly adhere to the surface of the meat. This was then placed in boiling water and boiled for 10 minutes followed by cooling in water at 20° C. 30 g of this were then filled into a pre-cooked food retort pouch followed by the addition of 170 g of curry sauce, and after sealing the pouch to be airtight, was pre-cooked by heating for 27 minutes at 122° C. (pressurized heat sterilization treatment).

### EXAMPLE 21

(Mechanical Mixing, Using a Mixing Kneader)

300 kg of beef were cut into bite-size pieces. A pre-mixed solution consisting of 6 kg of trisodium citrate, 12 kg of cornstarch and 12 kg of water was added thereto followed by mixing and kneading for 2 minutes with a 500 L horizontal screw kneader. This was then placed in boiling water and boiled for 10 minutes followed by cooling in water at 20° C. 30 g of this were then filled into a pre-cooked food retort pouch followed by the addition of 170 g of curry sauce, and after sealing the pouch to be airtight, was pre-cooked by heating for 27 minutes at 122° C. (pressurized heat sterilization treatment).

### EXAMPLE 22

(Target Food: Shrimp)

12 g of sodium bicarbonate and 25 g of potato starch were added to 1 kg of peeled shrimp and mixed to uniformly adhere to the peeled shrimp. This was then placed in boiling water and boiled for 5 minutes followed by cooling in water at 20° C. 30 g of this were then filled into a pre-cooked food retort pouch followed by the addition of 170 g of sauce, and after sealing the pouch to be airtight, was pre-cooked by heating for 45 minutes at 103° C. (pressurized heat sterilization treatment).

### EXAMPLE 23

(Target Food: Shellfish)

12 g of sodium bicarbonate and 25 g of potato starch were added to 1 kg of scallops and mixed to uniformly adhere to the scallops. This was then placed in boiling water and boiled for 5 minutes followed by cooling in water at 200° C. 20 g of this were then filled into container followed by the addition of 45 g of ingredients such as shrimp, mushrooms and carrots and 185 g of white sauce, and after sealing the container to be airtight, was pre-cooked by heating for 60 minutes at 103° C. (pressurized heat sterilization treatment).

### EXAMPLE 24

(Target Food: Fish)

2.4 g of trisodium citrate, 4.8 g of cornstarch and 0.6 g of salt were added to 120 g of sliced cod and mixed to uniformly adhere to the sliced cod. This was then placed in boiling water and boiled for 5 minutes followed by cooling in water at 20° C. This was then filled into a container, and after sealing the container to be airtight, was pre-cooked by heating for 23 minutes at 122° C. (pressurized heat sterilization treatment).

As has been previously described in detail, the present invention relates to a solid food such as processed meat imparted with the function of maintaining food texture and improving storageability, a cooked food containing the processed food as an ingredient thereof, and method for producing the same. According to the present invention, after adding and mixing, for example, an alkaline substance and a coating substance such as starch with a solid food, and adjusting the surface pH to be 6.0 to 13.0 and preferably 7.0 to 9.0, the resulting mixture is boiled by placing in boiling water to coat the surface of the meat with the coating substance followed by arbitrarily filling into a sealed container along with a flavoring liquid and carrying out heat treatment to provide a solid food in the form of a processed meat such as meat or seafood having extremely superior texture and yield, satisfactory flavor with little bitter taste, pungency or odor caused by the use of the alkaline substance, minimal decrease in quality even when stored for a long period of time, and superior storageability, as well as a cooked food containing the processed meat as an ingredient thereof, and a process for producing the same. While preferred embodiments of the invention have been described and illustrated above, it should be understood that these are exemplary of the invention are not to be considered as limiting. Various other modifications are also included without departing from the scope of the claims and within a range which can be easily conceived by a person with ordinary skill in the art. The contents of patent publications and other documents indicated in the specification are entirely incorporated herein by reference.

What is claimed is:

1. A method for producing a solid food imparted with an action of maintaining texture and improving storageability, comprising the steps of:
(a) contacting an alkaline substance and a coating substance with the surface of a raw solid food in which proteins have not been denatured by heat;
(b) coating the surface of the food with the coating substance by placing the food in a condition at a temperature equal to or higher than the temperature at which the protein in the food is denatured by heat and the coating substance thickens to form a coating;
(c) heating the food under conditions equivalent to or more than a temperature of 80° C. for 15 minutes; and
(d) carrying out at least the treatment of (a) to (c) in that order.

2. The method according to claim 1, wherein the alkaline substance is a carbonate, hydrogen carbonate or organic acid salt.

3. The method according to claim 1, wherein starch is used for the coating substance, and said coating treatment is carried out by coating in a condition at a temperature equal to or higher than the gelatinization temperature of the starch.

4. The method according to claim 1, wherein the contact treatment of (a) is carried out such that the alkaline substance and coating substance thinly and uniformly adhere to the surface of the solid food.

5. The method according to claim 1, wherein a powdered alkaline substance and coating substance are contacted with the surface of the solid food.

6. The method according to claim 1, wherein a mixed solution, in which the concentration of the alkaline substance is 0.1 to 40% by weight, the concentration of the coating substance is 30 to 70% by weight, and the ratio of the water is 30 to 70% by weight, is contacted with the surface of the solid food.

7. The method according to claim 1, wherein the alkaline substance and the coating substance are contacted with the surface of the solid food, and the solid food coated with the coating substance on the surface thereof is filled into a sealed container together with a flavoring liquid, or the surface of the solid food is coated with the coating substance when filling the solid food, for which the surface has been contacted with the alkaline substance and coating substance, into a sealed container together with a flavoring liquid, or when heating the solid food after filling.

8. The method according to claim 1, wherein, in the case where the processed solid food has been contacted with a dyeing agent which reacts with the coating substance at a cut cross-section thereof, the dye is able to be confirmed at least on the surface portion of the cross-section.

9. A processed meat for persons with depressed swallowing or chewing function, the processed meat being imparted with a function of maintaining texture and improving storageability, wherein the food is a meat which is subjected to heat treatment, retains an alkaline substance on the surface thereof, is coated with a coating substance, has a thickened coating formed on the surface thereof, is not subjected to shaping treatment, has a volume of 500 to 250000 mm³ or more, has a maximum stress of 5×10⁴ N/m² or less, and has a pH of 6 to 7.
